(19) United States
(12) Patent Application Publication
(10) Pub. No.: US 2016/0242406 A1
(43) Pub. Date: Aug. 25, 2016

(54) Pest Deterrent Device

(71) Applicant: William Chever, Hayward, CA (US)

(72) Inventor: William Chever, Hayward, CA (US)

(21) Appl. No.: 14/629,706

(22) Filed: Feb. 24, 2015

(51) Int. Cl. A01M 29/28

(52) U.S. Cl. CPC A01M 29/28

(57) ABSTRACT

A pest deterrent device for surrounding a plant includes a base member having a generally circular configuration and constructed of a non-conductive material. A battery is situated adjacent the base member. First and second conductive elements are coupled to an interior surface of the base member and electrically connected to the battery. The conductive elements and battery are configured such that electrical current is actuated when a conductive bridge, such as an insect or other pest, electrically connects the conductive elements. The base member includes a bottom wall, a lower portion extending upwardly from the bottom wall, and an upper portion connected to the lower portion and extending upwardly and inwardly so as to form a precipitation shield over the first conductive element and the second conductive element.

### BACKGROUND OF THE INVENTION

This invention relates generally to electric shock deterrent devices and, more particularly, to a pest deterrent device that utilizes the pest itself to close an electric circuit and actuate delivery of electric current and that shields conductive elements from precipitation.

Plants are often damaged by insects or other pests that climb on or feed on the plants. Specifically, insects such as snails, caterpillars, cutworms, beetles, and the like typically climb a plant stem until a desired portion of the plant is reached and on which to feed. Various methods have been used to control or eliminate pests from damaging plants, such as using chemical pest repellants, applying essential oils, growing pest resistant plants, and the like. Further, electrical shock devices have been used to apply a shock to undesirable pests in the vicinity of plants.

Although presumably effective for their intended purposes, the existing means for resisting pests from climbing onto or eating plants have the disadvantage of introducing chemicals that may be unsafe or otherwise undesirable for a garden environment. Further, the use of electrical shock devices for pest control presents undesirable conditions of constant electricity use and risk of shocking unintended persons or pets.

Therefore, it would be desirable to have a pest deterrent device that energizes spaced apart electrical conductive elements when a pest contacts both of them simultaneously. Further, it would be desirable to have a pest deterrent device having a precipitation shield that inhibits precipitation from contacting the electrical conductive elements.

### SUMMARY OF THE INVENTION

A pest deterrent device for surrounding a plant according to the present invention includes a base member having a generally circular configuration and constructed of a non-conductive material. A battery is situated adjacent the base member. First and second conductive elements are coupled to an interior surface of the base member and electrically connected to the battery. The conductive elements and battery are configured such that electrical current is actuated when a conductive bridge, such as an insect or other pest, electrically connects the conductive elements. The base member includes a bottom wall, a lower portion extending upwardly from the bottom wall, and an upper portion connected to the lower portion and extending upwardly and inwardly so as to form a precipitation shield over the first conductive element and the second conductive element.

Therefore, a general object of this invention is to provide a pest deterrent device that energizes a pair of spaced apart electrical conductive elements when a pest closes an electrical circuit with its body.

Another object of this invention is to provide a pest deterrent device, as aforesaid, that includes a precipitation shield that blocks the electrical conductive elements from precipitation.

Still another object of this invention is to provide a pest deterrent device, as aforesaid, that includes a battery electrically connected to the electrical conductive elements.

Yet another object of this invention is to provide a pest deterrent device, as aforesaid, having a plurality of ground stakes with which to anchor the device to a ground surface.

A further object of this invention is to provide a pest deterrent device, as aforesaid, having a base member that defines a central void configured to surround a plant to be protected from pests.

A still further object of this invention is to provide a pest deterrent device, as aforesaid, that is lightweight and inexpensive to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a pest deterrent device according to a preferred embodiment of the present invention;

FIG. 2 is an exploded view of the pest deterrent device as in FIG. 1;

FIG. 3a is a top view of the pest deterrent device as in FIG. 1;

FIG. 3b is a sectional view taken along line 3b-3b of FIG. 3a; and

FIG. 3c is an isolated view on an enlarged scale taken from FIG. 3b.

### DESCRIPTION OF THE PREFERRED EMBODIMENT

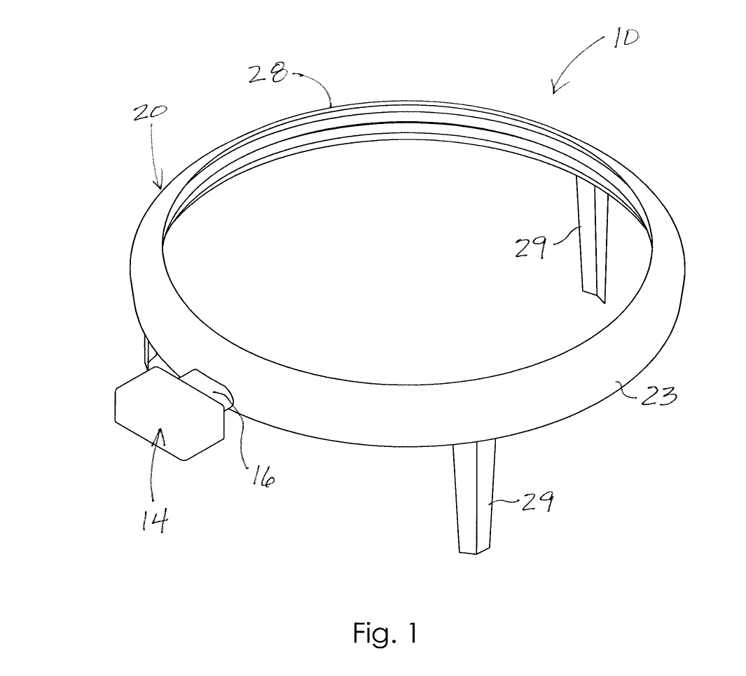

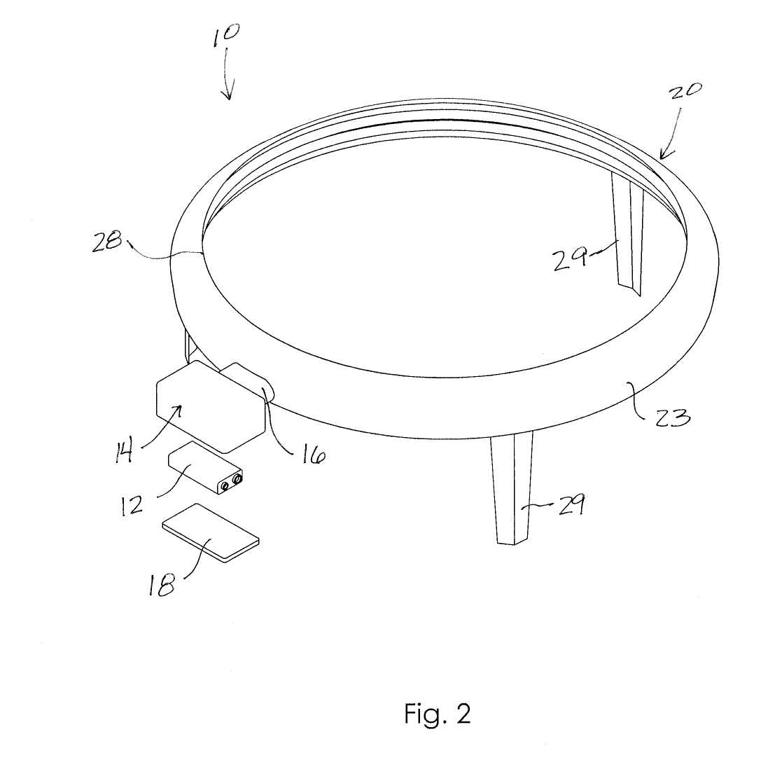

A pest deterrent device according to a preferred embodiment of the present invention will now be described in detail with reference to FIGS. 1 to 3c of the accompanying drawings. The pest deterrent device 10 generally includes a base member 20, first 30 and second 32 conductive elements, and a battery 12.

The base member 20 has a generally circular configuration, such as the shape of an inner tube or doughnut, although an ovular or rectangular shape would also work. The base member 20 defines an inner void having a diameter sufficient to enable the base member 20 to be positioned to surround a plant such as a flower, vegetable plant, or the like. In an embodiment, one or more ground stakes 29 may be coupled to a bottom of the base member 20 and extend downwardly therefrom. Preferably, the stakes 29 are spaced apart about the circular base member 20 and configured to pierce the soil of a ground surface so as to anchor the base member 20 to the ground. A free end of each stake 29 may form a tip or otherwise be configured to be pushed into the soil.

The first conductive element 30 is coupled to an interior surface of the base member 20 and extends all the way around the circular configuration. Similarly, a second conductive element 32 is coupled to the interior surface 21 of the base member 20 and extends all the way around the circular configuration. The conductive elements are spaced apart from one another in a parallel configuration. The first 30 and second 32 conductive elements may be referred to as an upper circuit ring and a lower circuit ring, respectively. Each conductive element may be constructed of copper wire or other material that efficiently carries electrical current when energized. For instance, copper wires may be plated with silver to increase conductivity.

The first 30 and second 32 conductive elements are electrically connected to the battery 12. In an embodiment, the first conductive element 30 may be coupled to the positive terminal of the battery 12 and the second conductive element 32 may be coupled to the negative terminal of the battery 12. More particularly, each respective conductive element may be electrically connected to a respective circuit connector that is then electrically connected to a respective terminal of the battery 12.

The conductive elements 30, 32 and their connections to the battery 12 are configured such that current from the battery 12 flows to the conductive elements only when a circuit is closed between them. In other words, current does not flow independently and no electrical “shock” is experienced when there is no conductive bridge or conductive connection between the first 30 and second 32 conductive elements. Conversely, the first 30 and second 32 conductive elements are actuated or energized with current from the battery 12 when the circuit is closed or “bridged” by another conductive element.

Conductive elements that can close or bridge an electrical connection between the first 30 and second 32 conductive elements include metal objects, a stream of liquid, or an actual living organism. For example, insects such as snails, caterpillars, cutworms, beetles, and the like typically climb a plant stem until a desired portion of the plant is reached and on which to feed. With the base member 20 surrounding a plant stem, a pest is likely to climb up the interior surface of base member 20 and step or slide atop the first conductive element 30 and then atop the second conductive element 32. As these insects are composed largely of water, their body provides an electrically conductive element sufficient to bridge or close the circuit and cause the first 30 and second 32 conductive elements to be energized by electric current from the battery 12. Needless to say, the pest is killed or at least knocked off of the base member 20.

A battery housing 14 may be coupled to an exterior surface 23 of the base member 20 and includes an interior area configured to hold the battery 12. The battery housing 14 may include a cubical or other box shaped configuration that defines an open interior space configured to receive the battery therein. The battery housing 14 may also include a channel portion 16 through which portions of respective conductive elements may be situated. The battery housing 14 may include a removable door 18.

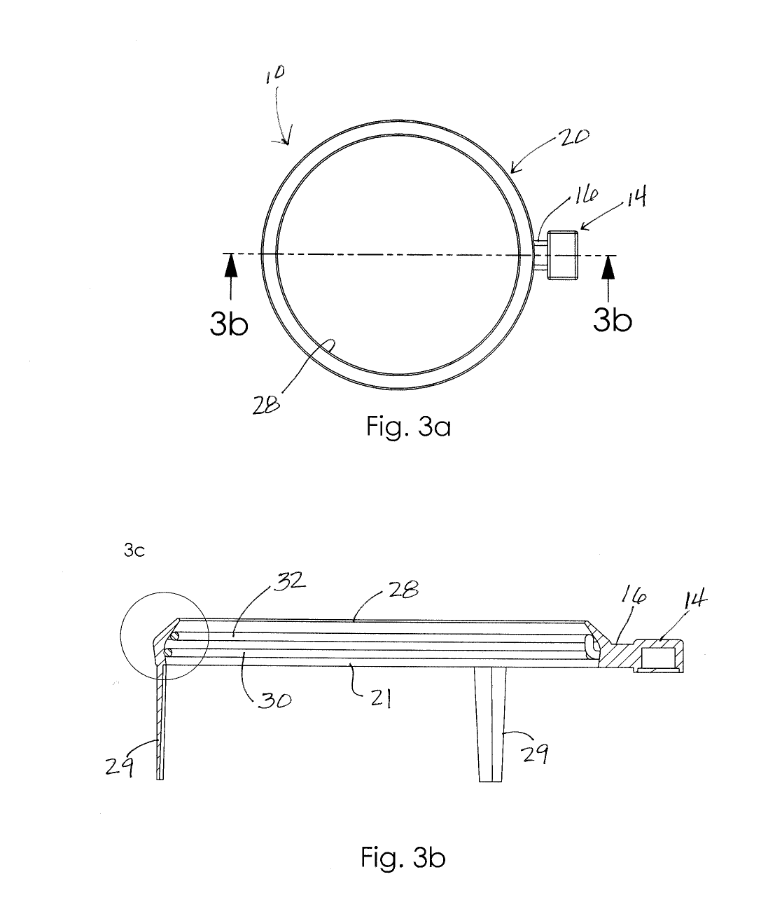

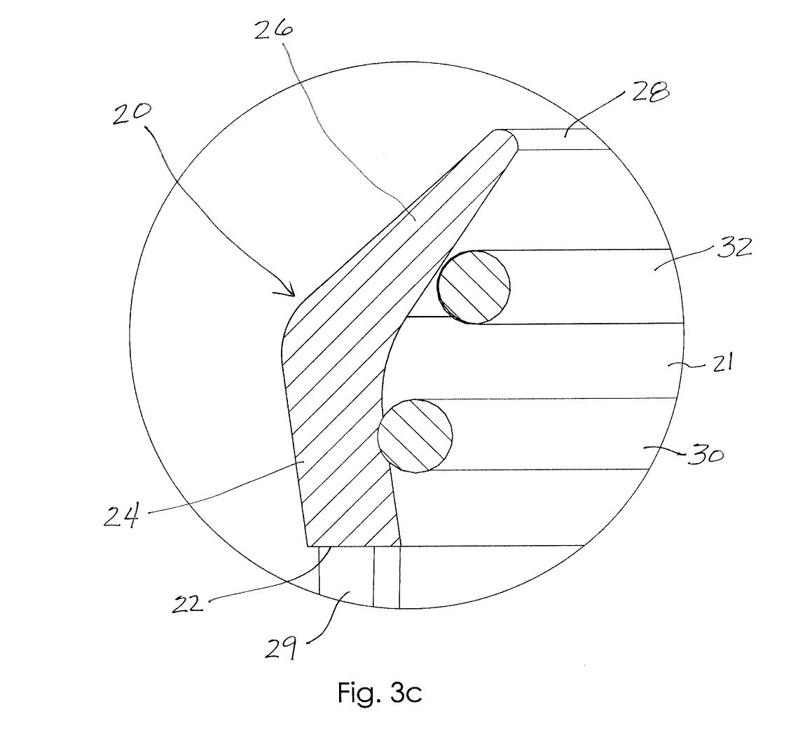

The base member 20 includes a bottom wall 22. A lower portion 24 of the base member 20 extends upwardly from the bottom wall 22. In one embodiment, the lower portion 24 may extend slightly rearwardly (FIG. 3c). An upper portion 26 of the base member 20 is connected to the lower portion 24 and extends upwardly and inwardly therefrom. The upper portion 26 includes a terminal end 28 that forms an open top of the base member 20 and that defines a diameter thereof.

The upper portion 26 of the base member 20 extends upwardly and inwardly at about a 45 degree angle although other angles would also work (FIG. 3c). The upper portion 26 forms an overhang that protects the interior surface from weather elements. In other words, the upper portion 26 is a precipitation shield that inhibits rain from landing on the conductive elements under most conditions. Rather, precipitation lands on the exterior surface of the upper portion 26 runs downwardly off of the base member 20 altogether. It is understood that receiving rain on the interior surface 21 of the base member 20 is undesirable as it may cause an undesired bridge or closure of the circuit between the first 30 and second 32 conductive elements, i.e. a “false alarm” by erroneously indicating a pest is touching respective conductive elements.

In use, the pest deterrent device 10 may be used to control pests such as insects that may otherwise damage plants such as vegetables, flowers, and the like. The base member 20 may be positioned to surround a plant. In other words, a plant may extend upwardly through the open area defined by the terminal end of the upper portion 26 of the base member 20. Then, as a pest crawls upwardly on the interior surface 21 of the base member 20, a circuit is closed between the first 30 and second 32 conductive elements and electric current energizes the conductive elements and neutralizes pest.

It is understood that while certain forms of this invention have been illustrated and described, it is not limited thereto except insofar as such limitations are included in the following claims and allowable functional equivalents thereof.

1. A pest deterrent device for surrounding a plant, comprising:
a base member having a generally circular configuration and constructed of a non-conductive material;
a battery situated adjacent said base member;
a first conductive element coupled to an interior surface of said base member and electrically connected to said battery;
a second conductive element coupled to said interior surface of said base member and electrically connected to said battery, said first conductive element being parallel to and spaced apart from said second conductive element;
wherein current from said battery flows circuitously between said first conductive element and said second conductive element when said first and second conductive elements are operatively connected by an electrically conductive bridge;
wherein said base member includes:
a bottom wall;
a lower portion extending upwardly from said bottom wall;
an upper portion connected to said lower portion and extending inwardly so as to form an overhang above said interior surface of said base member.

2. The pest deterrent device as in claim 1, wherein said bridge is a living organism.

3. The pest deterrent device as in claim 1, wherein said battery is positioned inside a battery compartment coupled to said base member.

4. The pest deterrent device as in claim 1, comprising a ground stake coupled to a lower end of said base member, said ground stake having a tip at a distal end thereof configured to enter a ground surface, whereby to anchor said base member.

5. The pest deterrent device as in claim 1, wherein said first conductive element and said second conductive element include a copper wire.

6. The pest deterrent device as in claim 1, wherein:
said first conductive element includes a first circuit ring; and
said second conductive element includes a second circuit ring.

7. The pest deterrent device as in claim 1, wherein said upper portion of said baser member extends upwardly and inwardly from said lower portion at about a 45 degree angle.

8. A pest deterrent device for surrounding a plant, comprising:
a base member having a generally circular configuration and constructed of a non-conductive material;
a battery situated adjacent said base member;
a first conductive element coupled to an interior surface of said base member and electrically connected to a positive terminal of said battery;
a second conductive element coupled to said interior surface of said base member and electrically connected to a negative terminal of said battery, said first conductive element being parallel to and spaced apart from said second conductive element;
wherein current from said battery flows circuitously between said first conductive element and said second conductive element when said first and second conductive elements are operatively connected by aqueous bridge;
wherein said base member includes:
a bottom wall;
a lower portion extending upwardly from said bottom wall;
an upper portion connected to said lower portion and extending upwardly and inwardly so as to form a precipitation shield over said first conductive element and said second conductive element.

9. The pest deterrent device as in claim 8, wherein said battery is positioned inside a battery compartment coupled to said base member.

10. The pest deterrent device as in claim 8, comprising a ground stake coupled to a lower surface of said bottom wall of said base member, said ground stake having a tip at a distal end thereof configured to enter a ground surface.
